(19) United States
(12) Patent Application Publication
(10) Pub. No.: US 2025/0384178 A1
(43) Pub. Date: Dec. 18, 2025

(54) INTELLIGENT DESIGN METHOD FOR LIGHTWEIGHT AND FATIGUE PERFORMANCE OF ALUMINUM ALLOY FRAME OF COMMERCIAL VEHICLE

(71) Applicant: Jilin University, Changchun City (CN)

(72) Inventors: Dengfeng WANG, Changchun City (CN); Yenan NI, Changchun City (CN); Wenchao XU, Changchun City (CN); Zihao MENG, Changchun City (CN); Xiaopeng ZHANG, Changchun City (CN)

(21) Appl. No.: 19/238,325

(22) Filed: Jun. 13, 2025

(30) Foreign Application Priority Data
Jun. 14, 2024 (CN) 202410768114.4

(51) Int. Cl. G06F 30/15

(52) U.S. Cl. CPC G06F 30/15

(57) ABSTRACT

Provided is an intelligent design method for lightweight and fatigue performance of an aluminum alloy frame of a commercial vehicle, including: establishing a conditional invertible neural network (cINN) model comprising a conditional and an invertible neural network; constructing a training sample set with multiple design variables and their corresponding performance responses; training the cINN model to obtain a frame structure optimization model; inputting a set of target performance responses into the model to generate a first design variable set; inputting this set back into the model to predict corresponding performance responses removing samples that do not meet the target performance responses, yielding an optimized design variable set; and selecting, from the optimized set, a sample set that meets the desired performance preference as the final frame design scheme.

### CROSS REFERENCE TO RELATED APPLICATION

This patent application claims the benefit and priority of Chinese Patent Application No. 202410768114.4, filed with the China National Intellectual Property Administration on Jun. 14, 2024, the disclosure of which is incorporated by reference herein in its entirety as part of the present application.

### TECHNICAL FIELD

The present disclosure relates to the technical field of automobile frame structure design, and in particular, to an intelligent design method for lightweight and fatigue performance of an aluminum alloy frame of a commercial vehicle.

### BACKGROUND

In the daily traveling process of a commercial vehicle, the frame of the commercial vehicle is under the combined action of multi-source, multi-directional spatial complex alternating dynamic loads of tension, compression, bending, torsion, and shearing. Structural damage may occur mainly in the form of fatigue failure. The computational expense is greatly increased for fatigue response as nonlinear response as compared with linear response such as stress and displacement. Moreover, the frame of the commercial vehicle has a complex and large-scale structure. Transverse and longitudinal beams made of an aluminum alloy by extrusion molding have complex cross-section shapes. Various interactions take place between various structures, materials, forming parameters, and fatigue performance. Accordingly, severe challenges are posed on a structure design method for fatigue performance of an aluminum alloy frame of a commercial vehicle. Therefore, high-accuracy fatigue life prediction and fatigue performance-oriented efficient structure design are important factors for guaranteeing the working reliability of a commercial vehicle, serve as key means for improving the research and development efficiency of a commercial vehicle product, and also are core techniques from “making bigger” to “making stronger” in the commercial vehicle industry of China.

In the prior art, the optimal performance responses meeting constraint conditions may be obtained mostly through simulation optimization of values of design variables, with long iteration time and low optimization efficiency. When the requirements on indicators such as the fatigue performance of the frame are changed, it is necessary to perform the tedious optimization iteration process again, which greatly prolongs the period and lowers the efficiency of development of an aluminum alloy frame of a commercial vehicle. For example, the Chinese patent application No. CN202310835438.0 discloses a topological optimization and manufacturing method for an aluminum alloy auxiliary frame of an automobile, which is intended to realize weight reduction of the auxiliary frame of the automobile by the steps of material replacement, topological optimization, and multi-disciplinary multi-objective optimization design, etc. With this technical solution, the calculation period for the fatigue life of the frame is long, resulting in low structural design efficiency.

Moreover, existing structural design methods for fatigue performance of a frame of a commercial vehicle mostly are based on structure optimization simulation on a target frame structure, and seldom involve a purely data-driven intelligent structural design method. As a result, design of experiments (DOE), surrogate model establishment, and optimization algorithm selection are limited by built-in functions of software and the target frame structure, and the selection of optimization parameters is subjective. Thus, human-induced subjective bias is introduced. The accuracy of the fatigue life prediction for the frame is low, which cannot meet the requirements of frame fatigue strength research and development. Early fatigue rupture may occur, or a large structural design margin is presented. The lightweight potential of the frame structure cannot be brought into full play. For example, the Chinese patent application No. CN202211169988.5 discloses a multi-attribute objective-driven aluminum auxiliary frame optimization design method, including linearly simplifying nonlinear fatigue performance to save the calculation time. This technical solution has the drawbacks of low calculation accuracy of the fatigue life, and restricted design space due to limitations of the framework of a target frame structure. Methods limited to commercial software fatigue modules also lack flexibility and generalization capability.

Existing techniques in which artificial intelligence methods and commercial vehicle frame structure design are combined are all intended to realize forward prediction from frame design variables to performance responses by means of neural network models, and to obtain frame structures meeting performance indicator requirements through iteration using optimization algorithms. A backward mapping design method for direct backward deduction of structural design parameters from performance requirements is seldom involved. As a result, there are technical gaps present for the existing intelligent structure design method for fatigue performance of an aluminum alloy frame of a commercial vehicle. For example, the Chinese patent application No. CN202111137812.7 discloses a multi-disciplinary lightweight optimization method and system for an auxiliary frame based on machine learning, including predicting performance responses by a machine learning model and performing iteration using an optimization algorithm until a frame structure meeting performance requirements is found. This technical solution is still limited by the optimization algorithm in essence although it achieves optimization on the iteration rate. The design efficiency needs to be improved, and linear response is mainly involved in optimization, whereas nonlinear fatigue response is not taken into account.

### SUMMARY

An objective of the present disclosure is to provide an intelligent design method for lightweight and fatigue performance of an aluminum alloy frame of a commercial vehicle. By establishing a machine learning-based intelligent design model with bidirectional mapping, design variables such as frame structure, size, beam section properties, and material parameters can be directly obtained through backward deduction according to performance indicator requirements such as the fatigue performance of the frame. An efficient and accurate backward mapping design from performance to structure is realized, thus improving the design accuracy and analysis efficiency of the aluminum alloy frame and shortening the research and development period of the frame.

The present disclosure adopts the following technical solutions:

An intelligent design method for lightweight and fatigue performance of an aluminum alloy frame of a commercial vehicle includes the following steps:
step 1: establishing a conditional invertible neural network model that includes a conditional neural network and an invertible neural network, and
establishing a training sample set that is composed of a plurality of design variables and corresponding performance responses thereof,
where the design variables include a frame structure parameter, a frame size parameter, and a frame material parameter; and the performance responses include a frame fatigue life, a maximum stress, a maximum deformation, a first-order natural frequency, and a mass;
step 2: training the conditional invertible neural network model with the training sample set to obtain a frame structure optimization model;
step 3: inputting a target performance response to the frame structure optimization model, and outputting, by the frame structure optimization model, a first design variable set;
step 4: inputting the first design variable set to the frame structure optimization model, outputting, by the frame structure optimization model, a frame performance response for each sample in the first design variable set, and deleting, from the first design variable set, a sample for which an output does not meet the target performance response, thereby obtaining an optimized design variable set; and
step 5: selecting, from the optimized design variable set, a sample meeting a performance preference as a frame design scheme.

Preferably, the establishing a training sample set includes:
with a parameter of an existing aluminum alloy frame structure of a commercial vehicle as an initial design variable, performing, using a Hammersley sampling method, uniform sampling within a numerical range of 50% above and below the initial design variable, thereby obtaining a plurality of design variables;
obtaining performance responses for the plurality of design variables using an experimental or simulation method, thereby forming original data; and
randomly sampling 80% of the original data as the training sample set, and using the remaining 20% of the original data as a test sample set.

Preferably, the conditional invertible neural network model includes eight coupling blocks, each coupling block using two fully connected layers; and each fully connected layer has 256 neurons, activated by rectified linear unit (ReLU).

Preferably, before step 2, the intelligent design method further includes: preprocessing the design variables, and training the conditional invertible neural network model with the preprocessed design variables,
where the preprocessing the design variables includes: standardizing the parameters of the design variables, and selecting parameters with greater contribution rates from the design variables using a principal component analysis method.

Preferably, parameters of which a sum of contribution rates is greater than 90% are selected from the design variables using the principal component analysis method.

Preferably, in step 2, Adam algorithm is used as an optimizer for reversible training and refinement training.

Preferably, in step 2, the training the conditional invertible neural network model includes:
minimizing a loss by maximum likelihood training of stochastic gradient descent, and saving a forward model with a minimum loss of an L2 norm loss function as a forward surrogate model,
where a maximum likelihood loss function is expressed by the following formula:

$$L ( z ) = \frac{1}{2} {z}^{2} - log \vert {detJ}_{x \to z} \vert$$

where L(z) represents the maximum likelihood loss function, z represents a latent variable, and log|det J_{x→z}| represents a log Jacobian determinant in transformation from a design variable x to the latent variable z; and
the L2 norm loss function is expressed by the following formula:

$${L}_{y} = {‖ y - {y}_{t} ‖}_{2}^{2}$$

where y represents a predicted value of the performance response, and yₜ is a true value of the performance response.

The present disclosure has the following beneficial effects:

1. In the present disclosure, machine learning and known data are combined. An aluminum alloy frame structure of a commercial vehicle is designed in a data-driven mode such that data utilization efficiency is increased.

2. In the present disclosure, a complicated formula derivation or tedious coupled finite element simulation process is replaced by training a machine learning model, and exhibits strong generalization ability. When requirements on indicators such as the fatigue performance of the frame are changed, a frame structure with selected performance indicators can be designed on demand easily and efficiently. The design efficiency of the aluminum alloy frame structure of the commercial vehicle is improved.

3. In the present disclosure, the step of manual parameter selection in response surface modeling is omitted. Instead, objective and rational analysis is performed on the data by simply relying on the machine learning model. The influence of human subjective factors in the prediction process is effectively avoided, and the prediction accuracy is increased.

4. The present disclosure breaks through the design limitations based on a target frame structure, proposes a backward mapping design framework for thoroughly and effectively sampling the whole design space, expands the design space, and enriches the designs of the aluminum alloy frame structure of the commercial vehicle.

### BRIEF DESCRIPTION OF THE DRAWINGS

FIG. 1 is a structural schematic diagram of an aluminum alloy frame of a commercial vehicle according to the present disclosure;

FIG. 2 is a flowchart of an intelligent design method for lightweight and fatigue performance of an aluminum alloy frame of a commercial vehicle according to the present disclosure;

FIG. 3 is a flowchart of simulation-based fatigue performance analysis based on secondary development according to the present disclosure;

FIG. 4 is a schematic diagram of variable selection using a principal component analysis (PCA) method according to the present disclosure;

FIG. 5 is a schematic diagram of training and test set distributions under best fit according to the present disclosure;

FIG. 6 is a structural schematic diagram of a conditional invertible neural network (cINN) according to the present disclosure; and

FIGS. 7A-7B are structural schematic diagrams of a coupling block according to the present disclosure.

### DETAILED DESCRIPTION OF THE EMBODIMENTS

The present disclosure will be further described in detail below with reference to the accompanying drawings, such that those skilled in the art can implement the present disclosure with reference to the description.

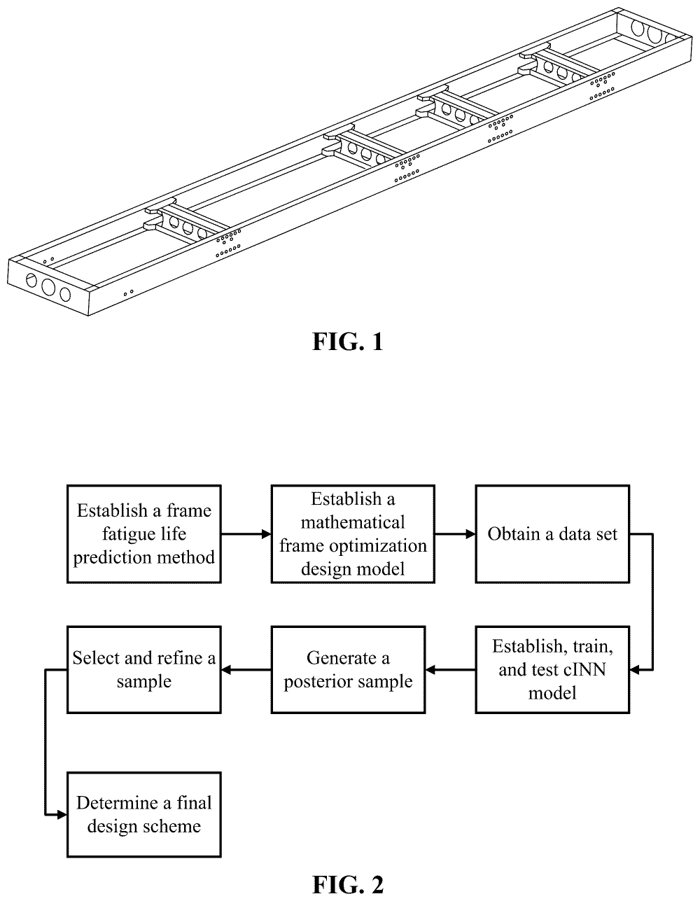

As shown in FIG. 1, an aluminum alloy frame of a commercial vehicle is mainly composed of a plurality of transverse beams and two longitudinal beams. The longitudinal beam is a channel beam. The components are connected by riveting or threaded connection.

As shown in FIG. 2, the present disclosure provides an intelligent design method for lightweight and fatigue performance of an aluminum alloy frame of a commercial vehicle. The design efficiency of the aluminum alloy frame structure of the commercial vehicle can be improved by fully utilizing existing data, and the accuracy of the fatigue life prediction can be improved.

The specific design method is as follows:

In step S1, a virtual prototype model of a commercial vehicle and a road model are established using Adams Car. According to use scenarios and operating conditions of the commercial vehicle, the virtual prototype model is allowed to travel on the corresponding road according to different scenarios and operating conditions. A time history of loads at assembly connection points of the frame with front and rear suspensions, a cab, a powertrain, a cargo box, and the like is extracted.

In step S2, rain flow counting is performed on the time history of loads in step S1, and a frame load spectrum is compiled.

In step S3, with Miner linear cumulative fatigue damage theory, the maximum fatigue damage of all the connection points is calculated. A reciprocal of the cumulative damage is calculated, which is the fatigue life of the frame structure.

A damage formula under the action of variable-amplitude cyclic loads is expressed as:

$$D = {\sum }_{i = 1}^{m} \frac{{n}_{i}}{{N}_{i}} \qquad ( 1 )$$

where m represents a number of different stress amplitudes, Nᵢ represents a life span under a stress amplitude obtained from an SN curve, and nᵢ represents a number of cycles under the same stress amplitudes.

In step S4, an aluminum alloy frame model of a commercial vehicle is established by a finite element method, and design variables (x1, x2, . . . xn) constraint conditions, and performance responses (y1, y2, . . . , yn) included in an initial data set are determined. The design variables include a structure parameter, a size parameter, and a material parameter of the frame. The structure parameter of the frame includes cross-sectional shape parameters (the width of the upper and lower flanges and the height of the web) of transverse and longitudinal beams, a number of transverse beams, and mounting position coordinates. The size parameter of the frame includes wall thicknesses of components of the frame. The material parameter includes common mechanical properties of the aluminum alloy, including Young's modulus, shear modulus, yield strength, safety coefficient, Poisson's ratio, density, and effective plastic strain. The performance responses include a frame fatigue life, a maximum stress, a maximum deformation, a first-order natural frequency, a mass, and the like. The constraint conditions for the frame optimization design are set, which include the maximum stress of the most dangerous part of the frame being less than a permissible stress of a corresponding material, the maximum deformation of the frame being less than a permissible deformation, the frame fatigue life being longer than a permissible value, and the first-order natural frequency of the frame being greater than a permissible value, etc.; and a multi-objective mathematical optimization design model for minimizing the frame mass and maximizing the fatigue life is hereby established. The common mechanical properties of the aluminum alloy are as shown in Table 1.

TABLE 1

| | | | | | | | |
|---|---|---|---|---|---|---|---|
| Attribute | Young's | Shear | Yield | Poisson's | | Effective | |
| Name | Modulus | Modulus | Strength | Ratio | Density | Strain | Plastic |

| | | | | | | |
|---|---|---|---|---|---|---|
| Abbreviation | E | G | SIGY | PR | Rho | EPS |

In step S5, according to the variables determined in step S4, random and uniform sampling is performed within the whole design space using a Hammersley sampling algorithm, and sampling ranges of 50% above and below initial states (original structural parameters of the aluminum alloy frame for the commercial vehicle to be optimized) are used for the design variables, and a distribution of sample points of the frame is obtained. The Hammersley sampling is suitable for the case where a response surface is highly nonlinear, performs better than Latin hypercube sampling in terms of uniformity, and is currently one of the most effective sampling measure for the fatigue response with nonlinear features. By this step, a uniformly distributed experimental design can be obtained rapidly, providing scheme guidance for subsequent establishment of a frame structure-fatigue performance data set by simulation or using an experimental method.

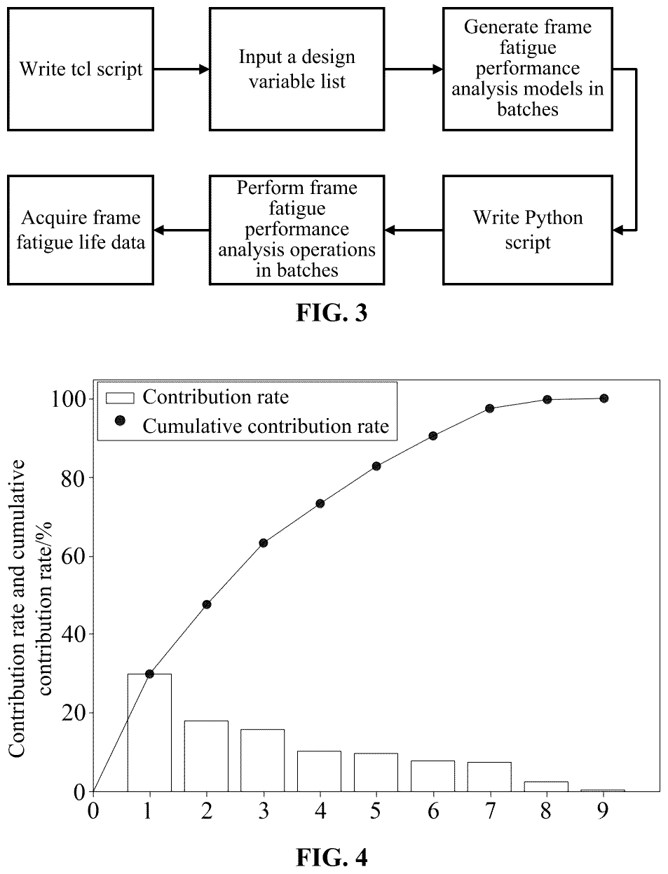

In step S6, in accordance with the sample points generated in step S5, the fatigue life of the frame structure is calculated by the frame fatigue life prediction method or the fatigue test method established in step S1, and the mass of the frame at each sample point is obtained by using a frame finite element model or physical weighing, and the maximum stress, the maximum deformation, and the first-order natural frequency are obtained by static simulation or experimental methods, thereby obtaining a dataset comprising design variables and corresponding performance responses. Finite element simulations are implemented using HyperMesh secondary development technique. Automated simulations are enabled through custom scripting: by inputting a design variable list of the frame structure, frame fatigue performance analysis models of different structures can be generated in batches, and simulated fatigue performance analysis is performed on models in batches with Python scripts, thereby obtaining a large quantity of fatigue life data. By using the secondary development technique, the human workload in the data acquisition process can be effectively reduced, and the efficiency of establishing the data set is improved. The simulated fatigue performance analysis process based on secondary development is as shown in FIG. 3.

In step S7, the initial data set in step S6 is loaded, and the data is standardized. It is necessary to perform standardization operation on the data prior to PCA operation, and the variables are controlled to be within the same range so that excessively capturing some features with large values by PCA can be prevented. The standardization operation includes the following steps: a continuous design variable such as thickness is standardized; a mean of the feature over the whole data set is set to μ, and a standard deviation thereof is set to σ; each value of the feature is first minus μ and then divided by σ to obtain each standardized feature value; and a missing design variable value is replaced with the mean of the feature.

In step S8, in consideration of performance influencing factors of the aluminum alloy frame of the commercial vehicle, the standardized data in step S7 is subjected to variable selection using the PCA method. Due to numerous design variables of the frame structure and the presence of interactions between the variables, the principal components in PCA are orthogonal so that the mutual influence between the original data components can be eliminated. Meanwhile, by PCA, variables can be selected from the data according to contribution levels of factors. Thus, variables with large contributions can be retained and used as design variables of a subsequent frame optimization model to establish a total data set. If this step is omitted, the final result may be overfitted, leading to poor prediction effect within a certain numerical range. The variables are selected by PCA so that the model training efficiency can be improved, and meanwhile, the mutual influence between the variables can be eliminated, guaranteeing the accuracy rate of the final design result. The method of variable selection is as shown in FIG. 4. The contribution levels are ranked, and the variables are selected from high to low contribution levels such that the sum of the contribution rates of the principal components exceeds 90%, guaranteeing the replacement effect of new variables. The above-mentioned variables are used as the design variables of the subsequent model to establish the total data set.

A formula of variable transformation in PCA is as follows:

$$Y = PX \qquad ( 2 )$$

where Y represents a data set matrix after dimensionality reduction with PCA, X represents a standardized original data set matrix, and P represents a matrix composed of eigenvectors of a covariance matrix C, arranged in the order of their corresponding eigenvalues.

A solution formula for the covariance matrix C is as follows:

$$C = \frac{1}{m} * X * {X}^{T} \qquad ( 3 )$$

where X^{T} represents a transposed matrix of the matrix X, m represents a number of columns of X, and C represents the covariance matrix of X.

In the present embodiment, the following 42 parameters are used as final design variables: the number, pitch, and diameter of bolts for a front end beam, a pitch of the bolts for the front end beam, a diameter of the bolt for the front end beam, a number of bolts for a second transverse beam, a pitch of the bolts for the second transverse beam, a diameter of the bolt for the second transverse beam, a number of bolts for a third transverse beam, a pitch of the bolts for the third transverse beam, a diameter of the bolt for the third transverse beam, a number of bolts for a fourth transverse beam, a pitch of the bolts for the fourth transverse beam, a diameter of the bolt for the fourth transverse beam, a number of bolts for a fifth transverse beam, a pitch of the bolts for the fifth transverse beam, a diameter of the bolt for the fifth transverse beam, a number of bolts for a rear end beam, a pitch of the bolts for the rear end beam, a diameter of the bolt for the rear end beam, the width of the top/bottom flange of the longitudinal beam, a height of a web, a thickness of the front end beam, the top flange thickness of the second transverse beam, the bottom flange thickness of the second transverse beam, the thickness of the second transverse beam web, the top flange thickness of the third transverse beam, the bottom flange thickness of the third transverse beam, the thickness of the third transverse beam web, the top flange thickness of the fourth transverse beam, the bottom flange thickness of the fourth transverse beam, the thickness of the fourth transverse beam web, the top flange thickness of the fifth transverse beam, the bottom flange thickness of the fifth transverse beam, the thickness of the fifth transverse beam web, the thickness of the rear end beam, the top flange thickness of the longitudinal beam, the bottom flange thickness of the longitudinal beam, the thickness of the longitudinal beam web, the thickness of the connecting plate for the second transverse beam, the thickness of the connecting plate for the third transverse beam, the thickness of the connecting plate for the fourth transverse beam, and the thickness of the connecting plate for the fifth transverse beam.

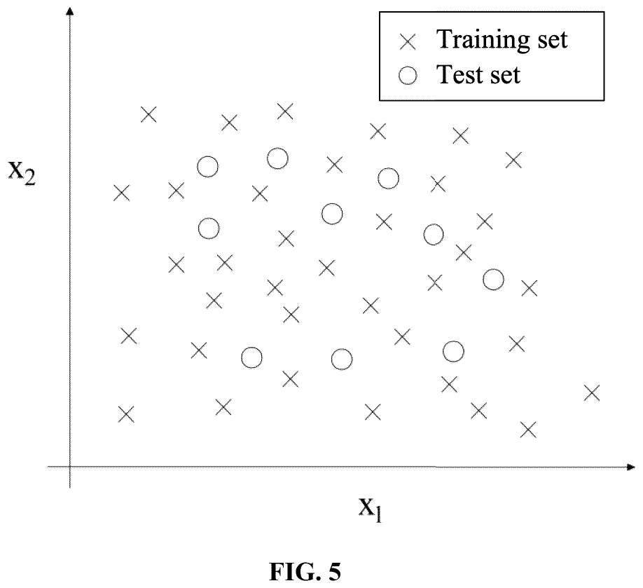

In step S9, the total data set in step S8 is randomly divided into a training subset and a test subset. 80% of the data is randomly sampled as a training data set for a conditional invertible neural network and the remaining 20% of data is used as a test data set for model accuracy. The training data set is configured to determine parameters of an invertible neural network model and establish the model, and the test data set is configured to evaluate the prediction effect of the subsequently established model. A distribution of a training set and a test set in case of best fitting is as shown in FIG. 5. When almost all of the data points of the test set fall within the boundary of the training set, overfitting or underfitting of the model can be avoided, and the prediction effect of the model can be improved.

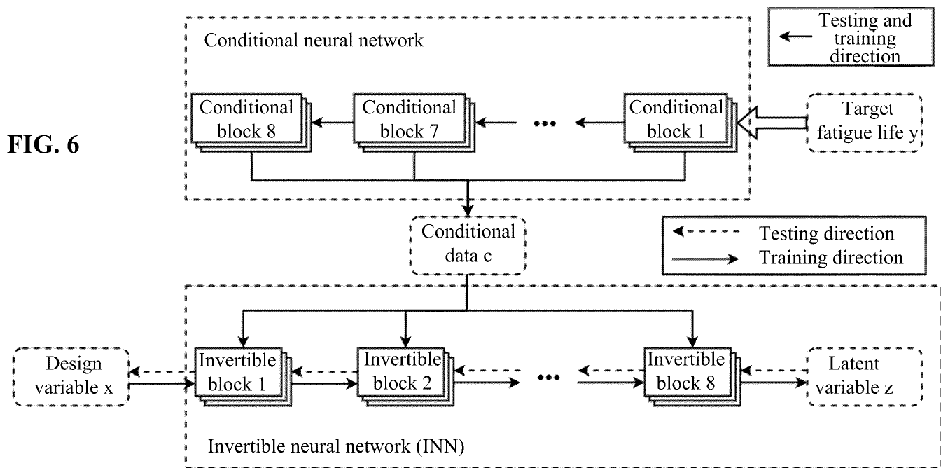

In step S10, a cINN model is trained and tested with all the training data sets and the test data sets obtained in step S9. The network structure is as shown in FIG. 6. A conditional invertible neural network (cINN) is obtained by combining an invertible neural network (INN) and conditional data. For the backward design problem, a latent variable z can be transformed to a design variable x with a given performance objective y as a condition.

The latent variable z in the cINN is a variable of information not interpreted when used for representing mapping of input data x to observable data y in the network training process. In brief, these variables help the network to learn how to map from input data to an observable result, and this process includes all factors that are not directly observed, but have influence on a result.

The cINN learns encoding by establishing bijective mapping (one-to-one correspondence) from a physical parameter x to an observable quantity y, while the latent variable z is configured to encode all information that results from x, but is not directly described by y. Such an architecture enables the network to convert part of information to z in a potential space in the learning process, and in this way, even though the observation data is insufficient, the physical parameter x can be predicted accurately.

Network parameters such as a number of coupling blocks, a number of network nodes, an activation function, and a maximum number of iterations are determined. The established cINN model uses 8 affine coupling blocks, each block using two fully connected layers. Each fully connected layer has 256 neurons, activated by ReLU. Adam algorithm is used as an optimizer for reversible training and refinement training, with a learning rate of 1E-3 and a weight decay rate of 1E-5. Weight factors λy and λz in the total loss of the INN are equal to 1. In order to stabilize the reversible training, small disturbance of Gaussian noise is added, where σy is 5E-3, and σz is 2E-3. A batch size of the reversible training is 500, and a number of training cycles is 1000. A single NVIDIA Geforce RTX 3060 graphics processing unit (GPU) is used, the average training time of each model is about 10 to 15 minutes.

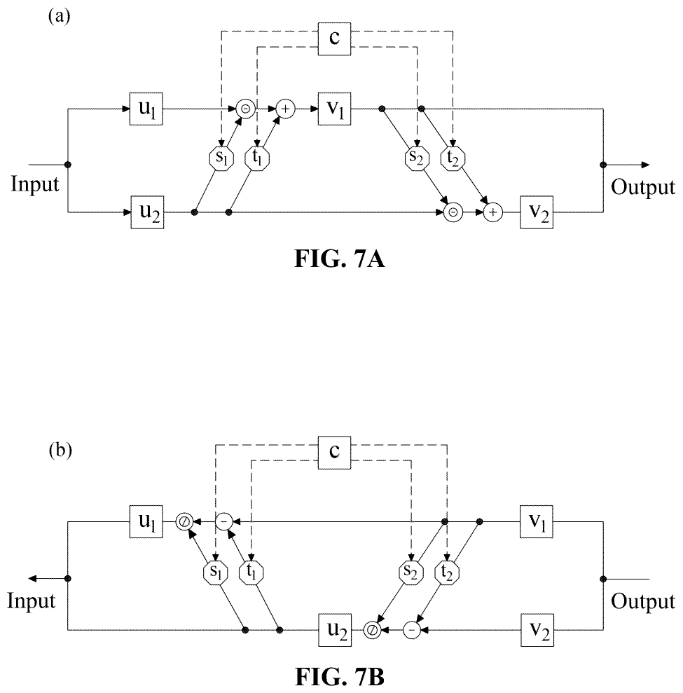

The affine coupling blocks are fundamental building component of the cINN. As illustrated in FIG. 7A, an input vector u to each coupling block is divided into two halves: u1 and u2, and elements are transformed by multiplication (and addition through an affine function with coefficients exp (si) and ti:

$$v 1 = u 1 ⊙ exp ( s 1 ( u 2 , y ) ) + t 1 ( u 2 , y ) \qquad ( 4 )$$

$$v 2 = u 2 ⊙ exp ( s 2 ( v 1 , y ) ) + t 2 ( v 1 , y ) \qquad ( 5 )$$

Output (v1, v2) is concatenated and passed to next coupling block. Similarly, the inverse transformation from (v1, v2) to (u1, u2) can be achieved by simply inverting the coupling block, as shown in FIG. 7B.

$$u 2 = ( v 2 - t 2 ( v 1 , y ) ) ∅ exp ( s 2 ( v 1 , y ) ) \qquad ( 6 )$$

$$u 1 = ( v 1 - t 1 ( u 2 , y ) ) ∅ exp ( s 1 ( u 2 , y ) ) \qquad ( 7 )$$

where Ø represents element-by-element division. Internal functions si and ti can be parameterized by arbitrary neural networks and optimized via backpropagation.

In step S11, weight coefficients of all losses are initialized. A loss is minimized by maximum likelihood training of stochastic gradient descent, and a forward model with a minimum loss of an L2 norm loss function is saved as a forward surrogate model.

A maximum likelihood loss function is expressed by the following formula:

$$L ( z ) = \frac{1}{2} {z}^{2} - log \vert {detJ}_{x \to z} \vert \qquad ( 8 )$$

where L(z) represents the maximum likelihood loss function, z represents a latent variable, and log|detJ_{x→z}| represents a log Jacobian determinant associated with the transformation process from a design variable x to the latent variable z.

The L2 norm loss function, also referred to as least square error (LSE), is expressed by the following formula:

$${L}_{y} = {‖ y - {y}_{t} ‖}_{2}^{2} \qquad ( 9 )$$

where y represents a predicted value of the performance response, and yₜ is a true value of the performance response.

In step S12, a random sample is generated from the latent space p(z), and a corresponding posterior sample (design variable) x is computed conditioned on a prior sample (latent variable z) and a given response y via invertible transformation.

In step S13, a sample generated in step S12 is selected. The generated sample is input to the forward surrogate model to predict the frame fatigue life. A sample of which the fatigue life does not meet the design requirement and a sample with a design variable going beyond the range of training are removed, thereby narrowing the selection range of design variable samples.

In step S14, the sample selected in step S13 is refined. In order to improve the prediction accuracy, the gradient at x is calculated by automatic differentiation in the forward surrogate model, and the sample is refined via gradient descent method, thereby obtaining the frame structure meeting the fatigue performance and lightweight design requirements.

In step S15, by weighing all alternatives obtained in step S14, the final design scheme of the aluminum alloy frame structure of the commercial vehicle is determined therefrom.

For example, if a lightweight level is required, the solution with the minimum mass response is selected as the design scheme. If the fatigue durability of the frame is required, the solution with the maximum fatigue life is selected as the design scheme. If small deformation of the frame is required, the solution with the minimum peak deformation amount is selected as the design scheme. If it is required that stress concentration should be avoided, the solution with the minimum maximum stress is selected as the design scheme. If the natural vibration characteristics of the frame are required, the solution with the maximum first-order natural frequency is selected as the design scheme.

The embodiments of the present disclosure have been disclosed above, which are not limited to the applications listed in the specification and implementations and can be absolutely applied to various fields suitable for the present disclosure. Additional modifications can be easily made by those skilled in the art. Therefore, without departing from the general concepts defined by the claims and equivalent scopes thereof, the present disclosure is not limited to specific details and the legends shown and described herein.

What is claimed is:

1. An intelligent design method for lightweight and fatigue performance of an aluminum alloy frame of a commercial vehicle, comprising the following steps:
step 1: establishing a conditional invertible neural network model that comprises a conditional neural network and an invertible neural network, and
establishing a training sample set that comprises a plurality of design variables and corresponding performance responses thereof,
wherein the design variables comprise a frame structure parameter, a frame size parameter, and a frame material parameter; and the performance responses comprise a frame fatigue life, a maximum stress, a maximum deformation, a first-order natural frequency, and a mass;
step 2: training the conditional invertible neural network model with the training sample set to obtain a frame structure optimization model;
step 3: inputting a target performance response to the frame structure optimization model, and outputting, by the frame structure optimization model, a first design variable set;
step 4: inputting the first design variable set to the frame structure optimization model, outputting, by the frame structure optimization model, a frame performance response for each sample in the first design variable set, and deleting, from the first design variable set, a sample for which an output does not meet the target performance response, thereby obtaining an optimized design variable set; and
step 5: selecting, from the optimized design variable set, a sample meeting a performance preference as a frame design scheme.

2. The intelligent design method for lightweight and fatigue performance of an aluminum alloy frame of a commercial vehicle according to claim 1, wherein the establishing a training sample set comprises:
with a parameter of an existing aluminum alloy frame structure of a commercial vehicle as an initial design variable, performing, using a Hammersley sampling method, uniform sampling within a numerical range of 50% above and below the initial design variable, thereby obtaining a plurality of design variables;
obtaining performance responses corresponding to the plurality of design variables using an experimental or simulation method, thereby forming original data; and
randomly sampling 80% of the original data as the training sample set, and using the remaining 20% of the original data as a test sample set.

3. The intelligent design method for lightweight and fatigue performance of an aluminum alloy frame of a commercial vehicle according to claim 1, wherein the conditional invertible neural network model comprises eight coupling blocks, each coupling block using two fully connected layers; and each fully connected layer has 256 neurons, activated by rectified linear unit (ReLU).

4. The intelligent design method for lightweight and fatigue performance of an aluminum alloy frame of a commercial vehicle according to claim 3, before step 2, further comprising: preprocessing the design variables, and training the conditional invertible neural network model with the preprocessed design variables,
wherein the preprocessing the design variables comprises: standardizing the parameters of the design variables, and selecting parameters with greater contribution rates from the design variables using a principal component analysis method.

5. The intelligent design method for lightweight and fatigue performance of an aluminum alloy frame of a commercial vehicle according to claim 4, wherein parameters of which a sum of contribution rates is greater than 90% are selected from the design variables using the principal component analysis method.

6. The intelligent design method for lightweight and fatigue performance of an aluminum alloy frame of a commercial vehicle according to claim 4, wherein in step 2, Adam algorithm is used as an optimizer for reversible training and refinement training.

7. The intelligent design method for lightweight and fatigue performance of an aluminum alloy frame of a commercial vehicle according to claim 6, wherein in step 2, the training the conditional invertible neural network model comprises:
minimizing a loss by maximum likelihood training of stochastic gradient descent, and saving a forward model with a minimum loss of an L2 norm loss function as a forward surrogate model,
wherein a maximum likelihood loss function is expressed by the following formula:
$$L ( z ) = \frac{1}{2} {z}^{2} - log \vert {detJ}_{x \to z} \vert$$
wherein L(z) represents the maximum likelihood loss function, z represents a latent variable, and log|detJ_{x→z}| represents a log Jacobian determinant in transformation from a design variable x to the latent variable z; and
the L2 norm loss function is expressed by the following formula:
$${L}_{y} = {‖ y - {y}_{t} ‖}_{2}^{2}$$
wherein y represents a predicted value of the performance response, and yₜ is a true value of the performance response.

8. The intelligent design method for lightweight and fatigue performance of an aluminum alloy frame of a commercial vehicle according to claim 5, wherein in step 2, Adam algorithm is used as an optimizer for reversible training and refinement training.

9. The intelligent design method for lightweight and fatigue performance of an aluminum alloy frame of a commercial vehicle according to claim 8, wherein in step 2, the training the conditional invertible neural network model comprises:
minimizing a loss by maximum likelihood training of stochastic gradient descent, and saving a forward model with a minimum loss of an L2 norm loss function as a forward surrogate model,
wherein a maximum likelihood loss function is expressed by the following formula:
$$L ( z ) = \frac{1}{2} {z}^{2} - log \vert {detJ}_{x \to z} \vert$$
wherein L(z) represents the maximum likelihood loss function, z represents a latent variable, and log|detJ_{x→z}| represents a log Jacobian determinant in transformation from a design variable x to the latent variable z; and
the L2 norm loss function is expressed by the following formula:
$${L}_{y} = {‖ y - {y}_{t} ‖}_{2}^{2}$$
wherein y represents a predicted value of the performance response, and yₜ is a true value of the performance response.
